(19) United States
(12) Patent Application Publication
(10) Pub. No.: US 2004/0154531 A1
(43) Pub. Date: Aug. 12, 2004

(54) Device for the application of reactive liquids

(76) Inventor: Bernward Bruns, Obdach (AT)

Correspondence Address: McGLEW AND TUTTLE, P.C., SCARBOROUGH STATION, SCARBOROUGH, NY, 10510-0827, US

(21) Appl. No.: 10/364,448

(22) Filed: Feb. 11, 2003

(51) Int. Cl. B05C 5/00

(52) U.S. Cl. 118/300

(57) ABSTRACT

A device for applying a reactive liquid, especially an adhesive, to an essentially level surface (3). The device comprises a liquid reservoir (4) and a plurality of outlet openings (8) for the liquid, which can be controlled and sealed by valves. The valves are formed by elastic, essentially tubular line segments (14), and the cross-sectional areas of the lines can be pinched off simultaneously by a clamping device (6). With the device the process safety and dependability in the application of reactive liquids, such as in the application of adhesive to the surface of panel materials, for example, can be improved significantly. At the same time, the costs incurred for the construction, production, operation and maintenance of a facility of this type can be reduced as a result of the simple structure

### FIELD OF THE INVENTION

The invention relates to a device for the application of a reactive liquid, especially an adhesive, to an essentially level surface, the device having a liquid reservoir and having a plurality of outlet openings for the liquid which are controlled and sealed by means of valves.

### BACKGROUND OF THE INVENTION

In the most various areas, especially in the automobile industry, in packaging, and in the construction industry, there is an increasing use of components, body panels and building materials produced in sandwich construction. Especially in civil engineering, the use of building and insulating materials in sandwich construction enjoys a rapid growth because of the especially advantageous static and thermal properties of these sandwich components.

Building materials in sandwich construction and/or sandwich components comprise, for example, but not exclusively, a light, usually highly thermally insulating core having on one or both surfaces a cover layer adapted to the application purpose, which is relatively thin relative to the thickness of the core layer, but is especially firm mechanically. Because of their advantageous characteristics profile, foamed polymers such as, for example, expandable Polyslyrol (EPS) or polyurethane foams are especially suitable for the core layer, while a wide variety of various materials, ranging from hard paper to fiberglass cloth, plastic and wood panels up to aluminum and steel plates are used for the cover layer(s). The core layers and cover layers are without exception connected two-dimensionally by means of suitable adhesives.

Especially with components subjected to high mechanical stress, such as in the construction industry, for example, the quality of the adhesive connection between the core layer and the cover layer plays a decisive role because the adhesive connection has to transmit high peeling forces and/or in the case of bending load of the components, in particular high shearing forces. The structural and qualitative demands on facilities and devices for connecting and/or gluing core layers and cover layers to one another are correspondingly high.

Because it is now possible to produce large-area panel materials, the even application of adhesive on the entire surface of the panels to be glued has a key function with respect to the quality of the glue joint. For reasons of a process-safe gluing of the plates, the adhesive is generally not applied to the panels two-dimensionally, but rather in hank-form from a plurality of single nozzles.

Thus, an evenly controlled outflow of the adhesive from the plurality of gluing station nozzles, of which there can be several hundred in the case of large-area panels, is required, while it must be possible to accurately control the start and finish of the adhesive application with the opening and closing of all nozzles openings.

Furthermore, for a quick setting, mostly highly reactive adhesives are used for such gluing, such as one-component polyurethane adhesives, which already set automatically within a few minutes after being applied to the panels due to the natural air humidity.

From the state of the art, devices for the application of such adhesives are known, where the adhesive to be applied is conveyed from a storage container to the application nozzles by means of electrical pumps and each of the application nozzles has its own closing valve, for example a needle valve, so as to be able to accurately regulate and control the application of the adhesive.

However, these typical devices are very prone to failure, especially with the use of reactive adhesives and because of the plurality of nozzles to be triggered and controlled. Thus, the penetration of only small quantities of ambient air, for example into the area of the nozzle valves, already causes the reaction adhesive there to set, and as a result, the respective valve becomes clogged and has to be exchanged. This furthermore leads to the production of rejects until the failure is noticed, and to the standstill of the facility and the corresponding breakdown costs until the required repair of the facility has been performed.

The situation is similar with the mechanical pumps used in the known facilities for the conveyance of adhesive. They, too, can be blocked or even destroyed if the penetration of even small quantities of humidity causes the polyurethane adhesive to set.

### SUMMARY OF THE INVENTION

Given this background, the problem to be solved by the present invention is to provide a device for the application of reactive liquids, especially reactive adhesives, that overcomes the aforementioned disadvantages. Especially, the device is supposed to have a simple structure and work dependably with a high failure- and fault tolerance, and simultaneously the cost and time effort for a required exchange of the individual application nozzles is to be kept to a minimum.

The device in accordance with the present invention comprises in a generally crown manner a liquid reservoir to receive the reactive liquid and/or the adhesive as well as a plurality of closable liquid outlets that can be controlled by means of valves, which are utilized for the hank- or line-shaped application of the liquid and/or the adhesive to a base and/or a material panel to be coated.

In accordance with the invention, however, the device is characterized in that the valves that control the outlet of the liquid and/or adhesive from the individual nozzles are formed by elastic, essentially tubular line segments and the flow-through cross-sections of a plurality of line segments can be pinched off simultaneously by means of a clamping device.

In other words, this means that the adhesive no longer emerges from the application nozzles through a plurality of needle valves that are operated individually and are prone to clogging, as is the case in the state of the art, but rather by simultaneously pinching off groups of elastic line segments. In that way, the line segments that can be pinched off can be present in the simplest case in the form of hose or tube lines made of elastic material, which lead from the liquid reservoir to the adhesive and/or liquid outlet openings, and the clamping arrangement is arranged between the liquid reservoir and the outlet openings, preferably near the outlet openings.

The valves in accordance with the invention, which are formed by elastic line segments that can be pinched off simultaneously, are especially advantageous in that an adhesive application device equipped with the valves does trot require any moving mechanical elements in the gluing area and/or any contact whatsoever with the adhesive. Because materials that do not bond with the adhesives can be used for the lines from the liquid reservoir to the adhesive outlet openings and for the line segments to be pinched off, a clogging of the lines and/or the valves and the outlet openings is practically impossible. Even in case of an unanticipated setting of adhesive residue in the area of the adhesive outlet openings and/or the valves, the problem can be resolved in the simplest way by merely exchanging the respective line segment and/or line end. This can be accomplished in a particularly simple way if, as provided in accordance with a preferred embodiment of the invention, the line segments forming the valves can be exchanged as individual modules.

These very simple repair efforts, which are also extremely rare with the application device in accordance with the embodiment of the invention, are furthermore very quick to execute compared to the high-effort repairs of the mechanical valves of known application devices and cause only a fraction of the costs incurred for the maintenance arid repair of the application devices known from the state of the art.

For the invention, it is initially not important in which way the liquid is transported from the liquid reservoir to the outlet openings for the liquid. For example, it is possible to transport the adhesive by means of mechanical pumps from the liquid reservoirs to the valves and/or to the outlet openings, as it is known from the state of the art. In accordance with one preferred embodiment of the invention, however, the liquid is transported from the liquid reservoir to the valves and/or the outlet openings by means of static and/or hydrostatic overpressure. It is especially preferred that the overpressure is generated by applying gas pressure to the surface of the liquid in the liquid reservoir.

Compared to transporting the liquid by means of electromechanical pumps, as it is known from the state of the art, this again, leads to the advantage of a significantly reduced susceptibility to failures on the one hand, and on the other hand to significant cost reductions in construction, production and maintenance for an adhesive application device designed in this way. In particular, the risk of the failure of mechanical pumps because of adhesive setting in the pumps, which regularly leads to the failure of the adhesive application devices known from the state of the art, is completely eliminated. Thus, the failure tolerance and dependability of an adhesive application device designed in this way can be significantly improved even further.

In accordance with another preferred embodiment of the invention, dry gas and/or dried gas is used for generating the static and/or hydrostatic overpressure by means of applying gas pressure to the surface of the liquid in the liquid reservoir. This means that any premature contact, especially between one-component polyurethane adhesive and water and/or air humidity, which could lead to premature setting of the adhesive, can be effectively avoided.

To enable a maintenance- and failure free operation of the adhesive application device over a long period of time, it is provided in accordance with another embodiment of the invention that the adhesive application device has a means to move the liquid outlet openings between a first position and a second position.

The application of the adhesive is performed in the first position of the is liquid outlet openings, and the liquid outlet openings are dipped into a tub with a protective liquid when they are in their second position. This is a protective liquid that prevents a polymerization of the adhesive left in the outlet openings as a result of air and or humidity sealing.

In this way, it is possible to avoid any undesired contact between the adhesive and the always humid ambient air, for example during work breaks in the adhesive application facility, in that the adhesive in the entire facility is sealed off hermetically from the ambient air. This leads to a further increase in the dependability and failure tolerance of the device intended for the application of adhesive.

It is especially preferred if the tub that holds the protective liquid can be connected to the adhesive application device by means of a quick locking system. This allows for a quick and uncomplicated exchange of the protective liquid bath, for example in cases of contamination by leaked residual quantities of adhesive.

For the realization of the invention, it is initially not important how the clamping means for pinching off the flow cross-sections of the line segments forming the valves is designed as long as it is ensured that they can dependably pinch off a plurality of line segments simultaneously. In accordance with a preferred embodiment of the invention, however, the clamping means has at least one clamping strip that can be operated pneumatically, hydraulically or electromechanically. With a clamping strip of this type, a plurality of line segments can be pressed together and pinched off simultaneously in a simple and dependable way.

It is especially preferred if the clamping strip is formed by do essentially cylindrical body. On the one hand, a clamping strip designed in this way can be produced simply and economically, while on the other hand, it leads to an especially gentle clamping and/or pinching of the line segments forming the valves.

In accordance with another preferred embodiment of the invention, the clamping means comprises a clamping block that receives the line segments forming the valves and forms an abutment for the clamping forces that are generated when the clamping strip is actuated. It is especially preferred if the clamping strip and the clamping block completely enclose the line segments forming the valves when the clamping means are in actuated condition. In other words, this means that especially the clamping block is formed in such a way that the line segments forming the valves are completely enclosed by the surface of the clamping block and/or the clamping strip in the area of the line segments where the pinching off is taking place when the clamping strip is actuated.

This is advantageous inasmuch as it allows the selection of especially soft and/or highly elastic materials for the line segments forming the valves without running the risk that the line segments may burst because of the overpressure in the adhesive application system.

In accordance with another preferred embodiment of the invention, the clamping means comprises a plurality of separately actuatable clamping strips. This is especially advantageous with adhesive application devices having a plurality of adhesive outlet openings. On the one hand, it is possible with such facilities, which can have up to several hundred adhesive outlet openings, to structurally simplify the actuation of the clamping strips and execute it with an increased failure tolerance, while on the other hand, the facility can be converted to various panel widths in a simple way and/or specific panel areas can be kept free from adhesive application, as needed.

In accordance with another preferred embodiment of the invention, the adhesive application device furthermore comprises a means to spray reaction liquid, especially water, onto the surfaces coated with adhesive and/or onto the adhesive application. In this way, the polymerization and/or setting of the applied adhesive can be accelerated in the sense of an increase of the machine throughput. This applies in particular to the frequently used one-component polyurethane adhesive.

The invention is explained in greater detail in the following by means of two illustrations, which show embodiments only. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a schematic representation showing an embodiment of an adhesive application device in lateral view;

FIG. 2 is an enlarged representation corresponding to FIG. 1 showing the area of the clamping means of the device in accordance with FIG. 1;

FIG. 3 is a top view of the area according to FIG. 2 in a representation corresponding to FIG. 2; and

FIG. 4 is a lateral view in a representation corresponding to FIGS. 1 to 3 showing an area of the adhesive application device according to FIG. 1.

### DESCRIPTION OF THE PREFERRED EMBODIMENT

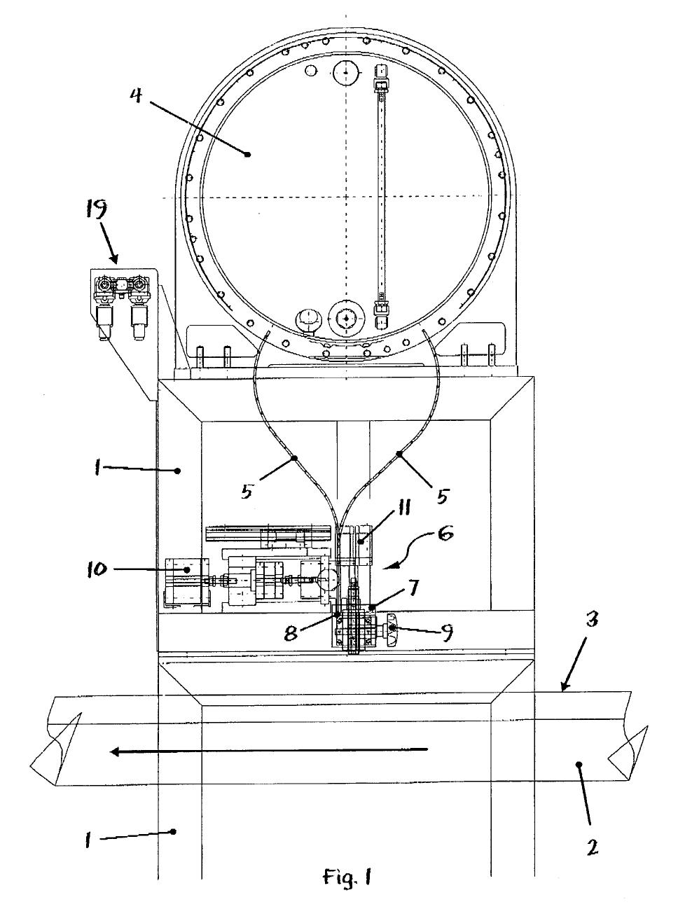

Referring to the drawings in particular, FIG. 1 shows an embodiment of an adhesive application device in a schematic lateral view. Shown first is a machine stand 1 having a lower area through which the panels 2 to be coated with adhesive can be guided in horizontal direction. The adhesive is applied to the surface 3 of the panels 2. Also shown is a liquid reservoir 4 developed as a pressure tank, from which the supply lines 5 lead to the clamping means 6.

Also shown is the tub 7 containing a protective liquid, with the outlet openings 8 of the adhesive supply lines 5 being immersed into the protective liquid during breaks in the operation of the facility to prevent an undesired setting of the adhesive in the outlet openings 8. The hand wheel 9 allows the operation of a quick locking system through which the tub 7, for example for cleaning purposes, can be detached from the adhesive application device in a quick and simple manner and/or be reconnected to the device.

The movement of the outlet openings 8 between the operating position in which the adhesive can be applied to the surface 3 of the panel 2 and the second position, where the outlet openings 8 are immersed into the protective liquid contained in the tub 7, is carried out in the shown embodiment of the adhesive application device by the pneumatic cylinders 10 and 11, with the pneumatic cylinders 10 being utilized for the displacement of the clamping means 6 with the outlet openings 8 in the horizontal direction, while the pneumatic cylinders 11 allow a movement of the tub 7 in the vertical direction toward the outlet openings 8 and/or away from the outlet openings 8.

Reference number 19 describes the spraying means that is used, for example, to spray water to the adhesive that has just been applied to the surface of panel 3 to accelerate the polymerization and/or setting of the applied adhesive, for example one-component polyurethane adhesive.

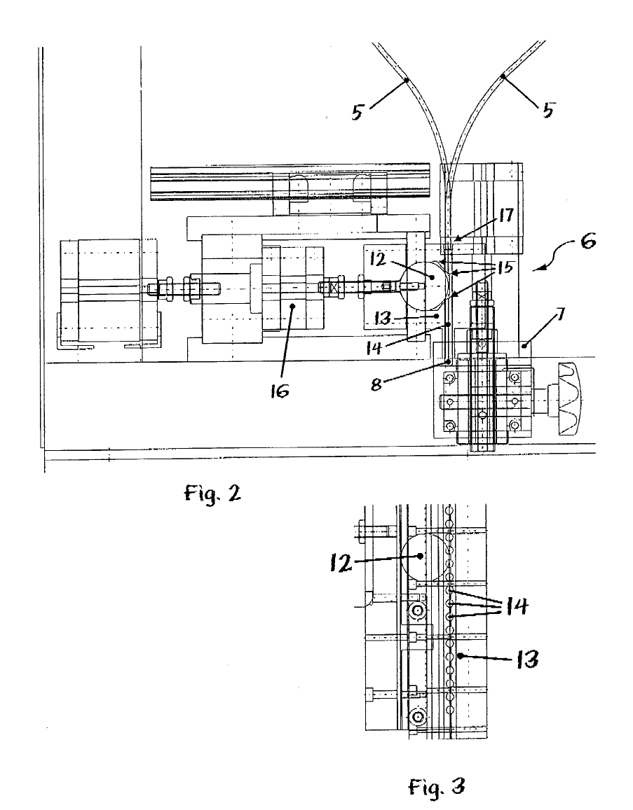

FIG. 2 shows an enlargement of the area of the clamping means 6 of the adhesive application device according to FIG. 1. FIG. 2 shows the adhesive supply lines 5, which direct the pressurized adhesive from the pressure tank 4 (not shown in FIG. 2) to the clamping means 6 and/or the outlet openings 8. Furthermore, FIG. 2 shows the structure and method of operation of the clamping means 6. FIG. 2 shows the cylindrical clamping strip 12, which runs perpendicular to the figure plan, and the clamping block 13, where the elastic line segments 14 are received and guided in corresponding perpendicular borings of the clamping block 13.

Together with a longitudinal recess in the clamping block 13, which also runs perpendicular to the figure level and is shown in the representation in FIG. 2 by means of its longitudinal edges 15, the interaction of the clamping strip 12 and the clamping block 13 thus leads to a complete enclosure of the elastic line segments 14 even in the actual clamping area between the clamping strip 12 and the clamping block 13.

This is especially advantageous in that it allows the use of an especially soft material for the elastic line segments 14 without the risk of a widening and bursting of the elastic line segments 14 due to the pressure that occurs in the elastic line segments 14 when the clamping means 6 is in closed condition according to FIG. 2.

The enclosure of the elastic line segments 14 forming the valves between clamping strip 12 and clamping block 13 is again emphasized by the representation in FIG. 3, where a part of the area around clamping strip 12 and clamping block 13 is shown in top view. Especially identified is a plurality of elastic line segments 14 as well as the course of the clamping strip 12; the round cross-section of the clamping strip being again shown in FIG. 3 to emphasize the position of the clamping strip 12.

Especially when looking at both FIG. 3 and FIG. 2 together, the enclosure of the entire circumference of the elastic line segments 14 between the clamping strip 12 and the clamping block 13 in the actuation and/or locking position of the clamping strip 12 becomes clear.

For the movement of the clamping strip 12 between the opening position and the actuating position of the clamping means 6 (shown in FIG. 2), pneumatic actuation cylinders 16 are utilized in the shown embodiment of the adhesive application device; the cylinders being able press the clamping strip 12 to the clamping block 13, thus pinching off the flow cross-section of the line segments 14 between the clamping strip 12 and the clamping block 13.

FIG. 2 also shows that in the—in view of the construction used—unlikely case of a clogging of an outlet opening 8 or an elastic line segment 14, the elastic line segments 14 can be exchanged very easily. To do so, only the affected elastic line segments 14 need to be pulled downward and out of the clamping block 13, which is very easy to realize because of the plug-connection 17 between the elastic line segments 14 and the adhesive supply lines 5.

The new elastic line segments 14 are then inserted into the vertical borings of the clamping block 13, again from the bottom, and reconnected with the adhesive supply lines 5 at reference number 17, with the adhesive application device being immediately operational again.

Furthermore, the tub 7 is also well visible in an enlarged representation of FIG. 2, the tub being utilized to receive the protective liquid into which the adhesive outlet openings 8 are immersed during operational breaks of the facility to avoid a setting of the adhesive in the adhesive outlet openings 8. The representation of FIGS. 1 to 4 shows the adhesive application device during an operating break, with the adhesive outlet openings 8 being immersed into the protective liquid bath in tub 7 during the break.

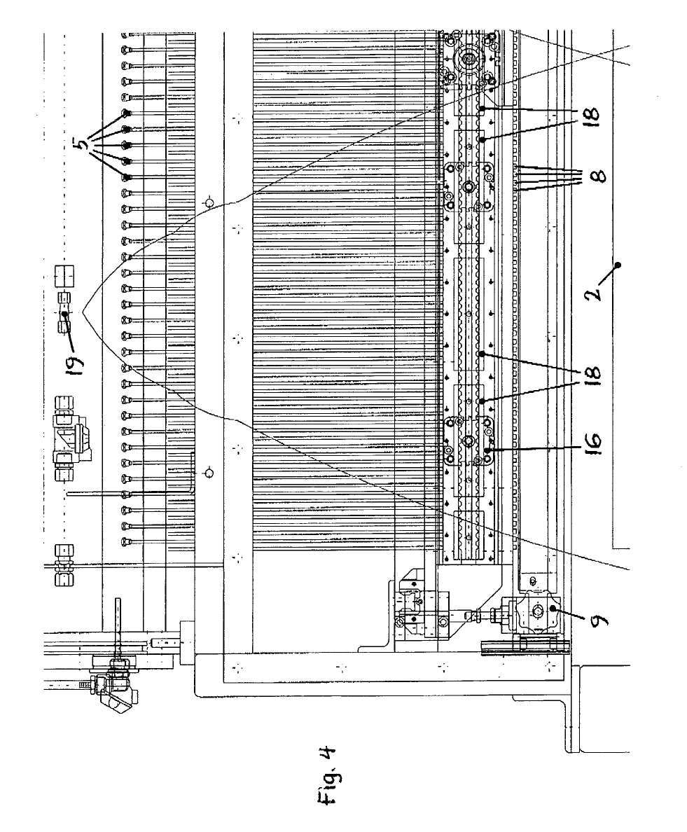

Finally, FIG. 4 shows the adhesive application device in accordance with FIGS. 1 and 2, partially in lateral view. First, it is obvious that the adhesive application device has a plurality of adhesive supply lines 5 and an equally high number of outlet openings 8, for reasons of simplicity and feasibility only a fraction of the entire number of adhesive supply lines 5 and outlet openings 8 being shown in FIG. 4.

FIG. 4 shows with special clarity the advantages of the design of the valve area 6 and the outlet openings 8 in accordance with the invention in comparison to the state of the art, where each individual outlet opening has a clog-prone, extravagant and costly mechanical valve and where the feed of the adhesive into the valve area 6 and/or to the outlet openings 8 is carried out by means of equally susceptible, extravagant and expensive mechanical pumps.

FIG. 4 also shows that the valve and/or clamping area 6 is subdivided into individual segments 18 over the length of the adhesive application device, the individual segments having respective independent actuating cylinders 16, not all of which are shown in FIG. 4 for reasons of clarity. Also shown in FIG. 4 is the tub 7 for receiving the protection liquid bath into which the adhesive outlet openings 8 are immersed during the operating breaks of the facility to ensure a hermetic seal of the adhesive contained in the facility and to stop the undesired setting of adhesive in the area of the valve and/or clamping means 6 arid/oar in the outlet openings 8.

The tub 7 is connected to the device by quick locking systems that can be operated with the hand wheels 9, thus allowing for a quick and easy removal of the tub 7 from the adhesive application device to allow the easy removal of adhesive residue, for example.

Finally, FIG. 4 also shows the spray nozzles 19, which are used to spray reaction liquid, in particular water if one-component polyurethane adhesive is used, onto the adhesive that has just been applied to the is panel 2 so as to achieve a quick polymerization and/or setting of the applied adhesive.

The end result shows that the adhesive application device in accordance with the invention leads to a significant improvement in the process safety and dependability of the application of adhesive to panel materials, with a simultaneous significant reduction in the costs incurred for the construction, production, operation and maintenance of a facility of this type.

While a specific embodiment of the invention has been shown and described in detail to illustrate the application of the principles of the invention, it will be understood that the invention may be embodied otherwise without departing from such principles.

What is claimed is:

1. A device for applying a reactive liquid to an essentially level surface, the device comprising:
a liquid reservoir having a plurality of outlet openings for the liquid;
a clamping means;
valves for controlling and sealing the respective openings, the valves being formed by elastic essentially tubular line segments each having a line cross-section that can be pinched off simultaneously by said clamping means.

2. The device in accordance with claim 1, wherein the line segments forming the valves can be exchanged as a single module.

3. The device in accordance with claim 1, wherein the transport of liquid from the liquid reservoir to the valves and/or the outlet openings is carried out by means of static and/or hydrostatic overpressure.

4. The device in accordance with claim 3, wherein the overpressure is generated by applying gas pressure to the surface of the liquid in the liquid reservoir.

5. The device in accordance with claim 3, wherein dry and/or dried gas is used to generate the overpressure.

6. The device in accordance with claim 1, further comprising:
means to move the outlet openings for the liquid between a first position, where the adhesive can be applied, and a second position, with the outlet openings for the liquid being immersed into a tub of protective liquid in the second position.

7. The device in accordance with claim 6, wherein the tub that receives the protective liquid bath can be connected to the device by means of a quick locking system.

8. The device in accordance with claim 1, wherein the clamping means comprises at least one pneumatically, hydraulically or electromechanically actuatable clamping strip.

9. The device in accordance with claim 8, wherein the clamping strip is formed by a cylindrical body.

10. The device in accordance with claim 1, wherein the clamping means comprises a clamping block.

11. The device in accordance with claim 10, wherein in the actuated condition, the clamping strip and clamping block completely enclose the line segments forming the valves.

12. The device in accordance with claim 8, wherein the clamping means comprises a plurality of separately actuatable clamping strips.

13. The device in accordance with claim 1, wherein the device has a means to spray reaction liquid including water onto the adhesive application.

14. An adhesive reactive liquid application device for applying an adhesive to a surface, the device comprising:
a liquid reservoir having a plurality of outlet openings for the liquid;
a clamping device;
elastic essentially tubular line segments each having a line cross-section that can be pinched off simultaneously by said clamping means, said tubular line segments forming valves for controlling and sealing the respective openings.

15. The device in accordance with claim 14, wherein the line segments are connected together to form a single module.

16. The device in accordance with claim 14, further comprising an overpressure device for generating and applying gas pressure to the surface of the liquid in the liquid reservoir wherein the transport of liquid from the liquid reservoir to the valves and/or the outlet openings is carried out by means of static and/or hydrostatic overpressure.

17. The device in accordance with claim 14, further comprising:
means to move the outlet openings for the liquid between a first position, where the adhesive can be applied, and a second position, with the outlet openings for the liquid being immersed into a tub of protective liquid in the second position.

18. The device in accordance with claim 14, wherein the clamping device comprises at least one pneumatically, hydraulically or electromechanically actuatable clamping strip formed by a cylindrical body and a clamping block, wherein in the actuated condition, the clamping strip and clamping block completely enclose the line segments forming the valves.

19. The device in accordance with claim 14, wherein the clamping device comprises a plurality of separately actuatable clamping strips.

20. The device in accordance with claim 14, further comprising: a spray device for spraying a reaction liquid onto the adhesive application.
